(19) United States
(12) Patent Application Publication
(10) Pub. No.: US 2009/0041962 A1
(43) Pub. Date: Feb. 12, 2009

(54) COMPOSITE CASTING PROCESS

(75) Inventors: Udo MERTENS, Balve (DE); Uwe Stoelzel, Menden (DE)

Correspondence Address: Muncy, Geissler, Olds & Lowe, PLLC, P.O. BOX 1364, FAIRFAX, VA, 22038-1364, US

(73) Assignee: Grohe AG, Hemer (DE)

(21) Appl. No.: 12/188,703

(22) Filed: Aug. 8, 2008

(30) Foreign Application Priority Data
Aug. 8, 2007 (DE) 10 2007 037 414.5
Jul. 8, 2008 (EP) 08012271
Jul. 15, 2008 (DE) 10 2008 033 086.8

(51) Int. Cl. B32B 1/00; B22D 23/00; B29C 39/10

(52) U.S. Cl. 428/34.4; 264/279; 428/35.7; 428/34.1

(57) ABSTRACT

A method for producing housings, especially for sanitary fixtures, is provided whereby a preformed hollow profile with a form-imparting enveloping material is provided. The enveloped hollow profile is placed in a casting mold, and a housing is produced by casting, such that during the casting process in the area of the connection sites a form-locking connection of the housing and the hollow profile forms.

This nonprovisional application claims priority under 35 U.S.C. §119(a) to German Patent Application No. 10 2007 037 414.5, which was filed in Germany on Aug. 8, 2007, and which is herein incorporated by reference.

### BACKGROUND OF THE INVENTION

1. Field of the Invention

The present invention relates to a process for producing castings, especially for sanitary fixtures and castings for sanitary fixtures.

2. Description of the Background Art

Manufacturing processes for castings, especially for sanitary fixtures, are often designed as cast parts in permanent molds, since these can be made easily even with complicated molding designs. For guiding the fluid within the cast housing it is known to introduce channels which, depending on the number and arrangement of the desired channels, require complicated casting core molds. For producing the molding cores, molding sand, mixed with binders in a core-shooting machine with a certain shooting pressure and a certain shooting temperature, is pressed into a core mold. After hardening of the casting core formed in this manner, it is placed in the casting mold. After completion of the casting, the sand is removed through openings placed in the casting.

One drawback of the customary casting methods is that frequently high wall thicknesses are produced, which would not be necessary on the basis of the loads occurring. As a result, too much base material is consumed for the casting, leading to high material and production costs. It is known from EP 0 638 381 B1 that a housing for a hydraulic feed device may be produced by a pressure casting process in which a compression chamber is formed by a core introduced into the casting mold and remaining in the housing after the casting.

Furthermore it is known from DE 41 02 358 A1 that a molded article may be produced by a pressure casting process, wherein inserts can be arranged in the molded piece to achieve functional cavities.

### SUMMARY OF THE INVENTION

It is therefore an object of the present invention to provide a thin-walled casting, especially for sanitary fixtures, with cavities and/or channels for conveying media rapidly and cost-advantageously and to overcome the drawbacks of the state of the art.

Thus an embodiment of the present invention provides a process for producing molded articles, especially for sanitary fixtures, by performing the following steps, which can be in succession. First a preformed hollow profile is placed in a casting core. To produce the casting core, for example in a core shooting machine, molding sand mixed with binder is pressed into a core mold with a certain shooting pressure and at a certain temperature. It is likewise possible to use an enveloping material, for example casting ceramic or plastic, which, using different methods, surrounds the hollow profile and withstands the subsequent enveloping process. Finally the hollow profile is enveloped with a suitable material and forms the final surface geometry in somewhat shrunken form. Then a coupling layer can be applied in the area of connecting points of the hollow profile. The connecting points project out of the enveloping material. Then the enveloped hollow profile is placed in a casting mold. Subsequently the manufacturing and casting of the hollow profile with enveloping take place in such a way that in the casting process a tight bond of casting body and hollow profile forms in the area of the connecting points. During the casting process, the casting material envelops the hollow profile, wherein the melting point of the casting material is below that of the material of the hollow profile. In this way it is accomplished that the hollow profile itself is not melted. During casting, merely the coupling layer is molten, thus creating a tight connection between the hollow profile and the casting. The application of a coupling layer and the production of a media-tight connection, however, are not absolutely necessary. A slight gap is not basically harmful if media-tightness is not necessary or if this can be sealed later with another process.

In an embodiment, only a preformed hollow profile for carrying hot water and a preformed hollow profile for carrying mixed water are provided. For the cold water, only a connecting mold piece for the connection on the house side is provided. This means that the cold water surrounds the entire inner space of the housing and the other pipes of the water channel. The advantage of this design lies in the fact that the surface of the casting always remains cold, even when hot or warm water flows through the water control, achieving a so-called “cool touch effect.” The individual hollow profiles are thereby connected together before being placed in the casting mold so that a tight water channel module is produced independently of the housing. Then the water channel module is enveloped with a suitable enveloping material such as sand, which determines the inner contour of the casting and produces the fixture. After the casting process, the enveloping material can be removed through the connection for the cold water.

In this embodiment, the connecting piece on the hot water side can be sealed to the cast surface-enveloping piece during or after the casting process.

An additional design of the invention provides that a premolded hollow profile is also provided for a cold-water passage. This design has the advantage that all media conduits can be made from hollow profiles and the water channel is thus independent of the surface-enveloping piece. Separating the media pathways and surface enveloping piece results in the advantage that the media control can be optimally adapted to the medium on the material side and negative effects on the medium flowing through can be avoided.

In the present case, a completely closed article can be produced in the casting process. The molding sand from the cast core can also remain in the casting in this process. In this way it is possible to avoid residues of the molding sand being introduced into the galvanization baths, etc., during the subsequent processing and coating, and additionally to have a thermal insulating effect from the outside.

In addition, a premolded hollow profile or a molded article for receiving functional elements, especially a mixing or thermostatic cartridge, preferably is to be provided. All hollow profiles, for example, can be produced by deep drawing, tubular molding or heat forming. Specifically a manufacturing process by heat forming offers the advantage that the functional elements can be accurately adapted after the manufacturing process. The surface-enveloping piece for the sanitary fixture in this embodiment merely represents a housing or casing for the water channel and gives the fixture its external contour. Because of this, the thickness of the housing can be reduced, leading to enormous material savings.

According to another embodiment, the hollow profiles provided for the water channels may already have the required connection geometries, especially threading, before the casting process. In this way, subsequent mechanical processing of the entire fixture will no longer be necessary.

Further a casting for a sanitary fixture is provided, wherein a hot water channel and a mixed water channel made of premolded hollow profiles are arranged. It is thereby possible to distinguish between two different manufacturing methods.

On one hand the preformed hollow profiles with enveloping material can be placed in a casting mold before the casting process. On the other hand the preformed hollow profiles, after producing the housing, can be bonded into the already cooled castings. In the latter case, additional sealing means can be provided for tighter connection between the hollow profiles and the casting.

Another embodiment provides that the hollow profiles are connected with the casting in a form- and/or material-locking manner. In this type of manufacturing, the hollow profiles with enveloping material are already placed in the casting before the casting process. If no coupling layer is applied to the hollow profiles, a form-locking connection is achieved by the casting process; if a coupling layer is applied and this layer is melted, a form-locking connection is achieved between the hollow profile and the casting.

Supports for functional elements, especially mixing cartridges or temperature control cartridges can also be provided in the housing. These can be introduced into the housing by mechanical processing, by drilling and milling, or can be incorporated into the casting by, for example, preformed hollow profiles or molded pieces.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 illustrates a first water channel made of preformed hollow profiles and molded pieces in an exploded view;

FIG. 2 illustrates a back view of the water channel from FIG. 1 in the assembled state;

FIG. 3 illustrates a front view of a sanitary fixture with a housing in accordance with the invention and the water channels connected in;

FIG. 4 illustrates a section along line IV-IV through the fixture of FIG. 3;

FIG. 5 illustrates a section along line V-V through the fixture of FIG. 3;

FIG. 6 illustrates a second water channel made of preformed hollow profiles and molded pieces in an exploded view;

FIG. 7 illustrates a section along line VII-VII through a tub fixture according to FIG. 8;

FIG. 8 illustrates a front view of the tub fixture with a housing in accordance with the invention and connected-in water channel;

FIG. 9 illustrates a section along line IX-IX through the fixture from FIG. 8; and

FIG. 10 illustrates a section along line X-X through the fixture of FIG. 8.

### DETAILED DESCRIPTION

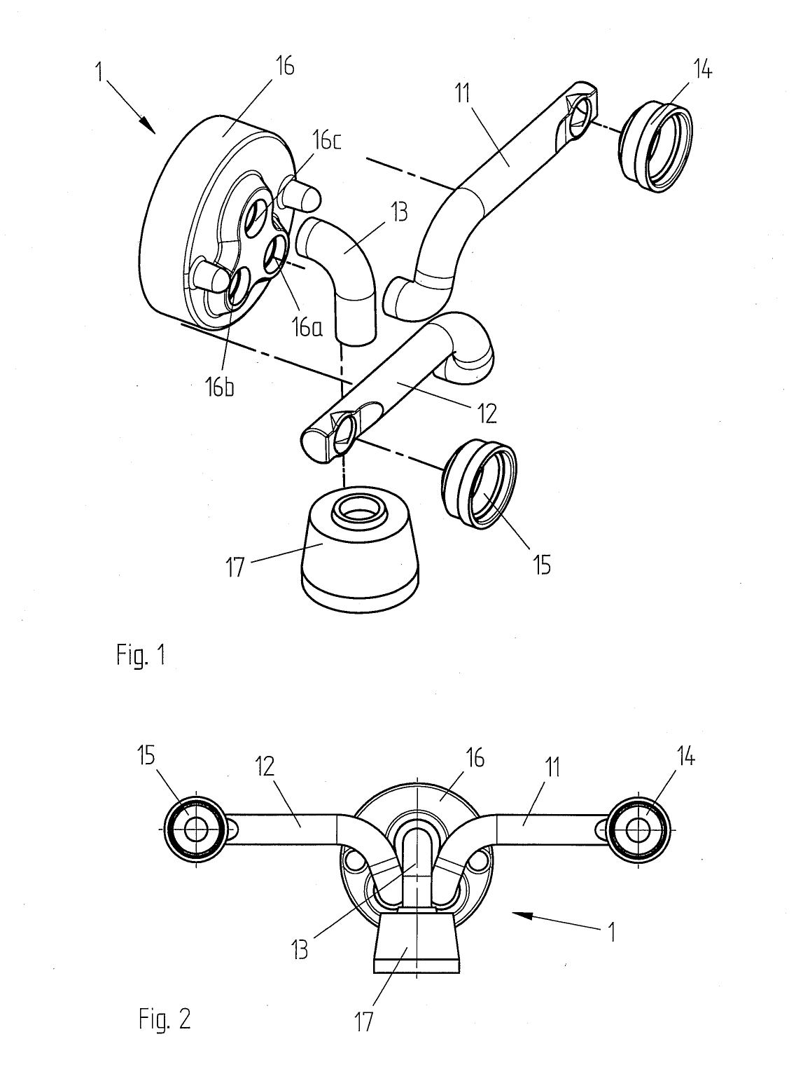

FIG. 1 shows the individual parts of a water channel 1, for example, for a single-lever shower fixture. The water channel 1 comprises a molded connecting piece 14 for a hot water connection and a molded connecting piece 15 for a cold water connection. The two connecting molded pieces 14, 15 on one side have an inner geometry for connection to the house-side water connections and an external geometry for connection to a casting for a housing. On the opposite side, the molded connection pieces 14, 15 are shaped such that they can be tightly connected with a preformed hollow profile 11, 12 which serves as the water pathway for hot water or the water pathway for cold water. The water pathways 11, 12, which in the present case includes pre-bent pipes, have radial inlets for connection with the connection-molded parts 14, 15. For this purpose the pipes are flattened in the area of the connection site, which simplifies the arrangement of the sealant and a fluid-tight connection. As an alternative, the pipes may also have a further curvature and be connected axially with the connection molded piece.

Both the water pathway for hot water 11 and the water pathway for cold water 12 open into a further molded piece 16, which is provided for accommodating a functional component, in this case a mixing cartridge. For this purpose the molded piece 16 has three openings 16a, 16b, 16c, namely a hot water inlet 16a and a cold-water inlet 16b and a mixed water outlet 16c. A water pathway 13 for mixed water thus connects the mixed water outlet 16c with the further molded piece for outflow 17.

FIG. 2 shows the completely assembled and connected water channel 1 from the rear. In this condition the water channel 1 is shot into a sand core or the sand core is pressed around the water channel 1 and then placed in a casting mold. Then the coupling points to the connection molded parts 14, 15 the outlet 17 and the molded piece 16 are provided with a coupling layer, for example a hard solder. This is followed by the usual casting process for producing a corresponding housing 2.

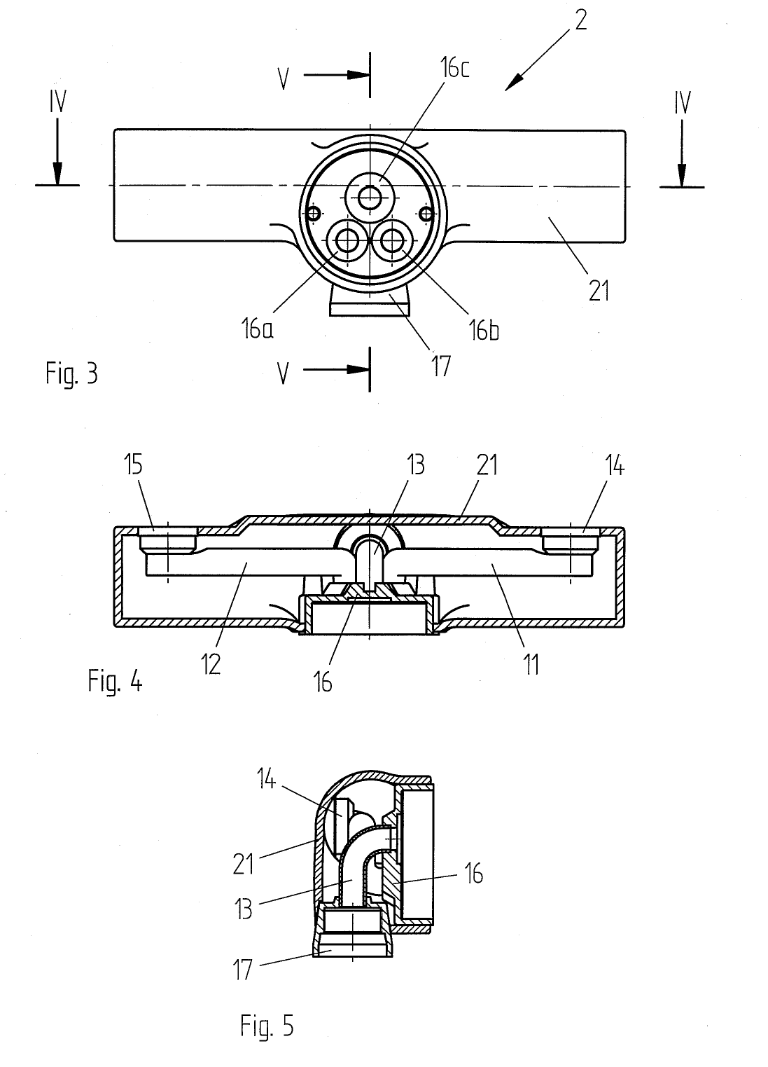

FIG. 3 shows a front view of the compact form of the sanitary fixture. The housing 2 has only an opening for inserting a valve cartridge and an opening for outflow. In the present case, therefore, the sand core remains in the housing after casting. Since this [housing] is tightly sealed at the connection points, the sand can no longer emerge and remains in the housing as an insulating layer. Alternatively this sand core can be removed through a borehole after casting.

In the sections of FIGS. 4 and 5 the simple design of the inner space of the casting becomes clear, wherein any embodiments for the outer contour whatsoever are possible. Finally, the housing 2 has only a thin outer shell, in which the connecting molded parts 14, 15 and molded pieces 16, 17 are connected in a material-locking way.

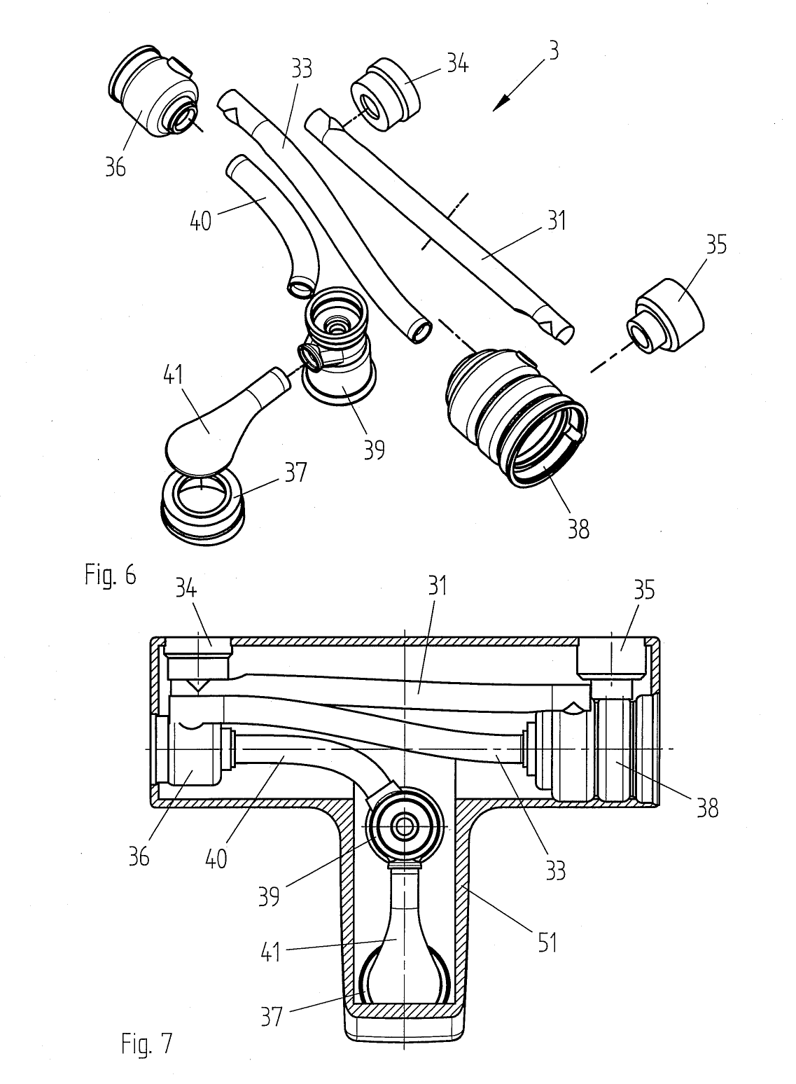

FIG. 6 shows the individual parts of a second water channel 3 for a tub fixture. The water channel 3 again has a connection molded piece 34 for a hot water connection and a connection molded piece 35 for a cold-water connection. Whereas the connection molded piece 34 for hot water opens into a water pathway 31 for hot water, having a pipe with radial inlets and outlets, the connecting molded piece 35 for cold water opens directly into a molded piece 38 for a thermostat element. In addition to the two inlets for cold and hot water, the molded piece 38 also has an outlet for mixed water, which is conveyed through a water path 33 to a molded piece 36 for a cutoff valve. From there it proceeds through an additional curved pipe 40 over a molded piece 39 for redirection to the outlet 37.

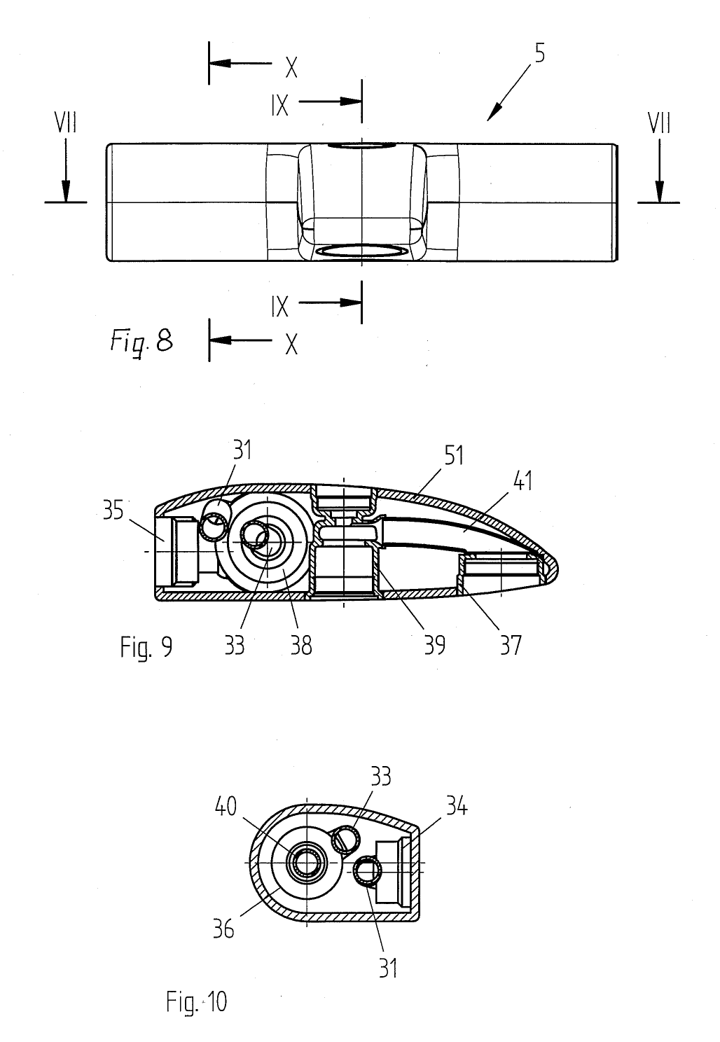

FIG. 8 shows a front view of the compact shape of the sanitary fixture. The housing has only one opening for inserting a redirection device and an opening for the outflow.

The sections of FIGS. 7, 9 and 10 clearly show the compressed way in which the water channel can be arranged with the aid of the molded pieces and hollow profiles and thus be adapted to the geometry of the housing.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for producing housings, especially for sanitary fixtures, the method comprising:
at least partial enveloping a preformed hollow profile with a shape-imparting enveloping material;
inserting the hollow profile with the enveloping material into a casting mold; and
casting and producing a housing such that during the casting process, in an area of connection pieces of the hollow profile, a form-locking connection is produced between the housing and the hollow profile.

2. The method according to claim 1, wherein after enveloping the hollow profile, a coupling layer is applied in the area of the connecting points of the hollow profile such that during casting and preparation of the housing, a material-tight connection arises between the housing and the hollow profile.

3. The method according to claim 1, wherein a preformed hollow profile for a mixed water channel is provided.

4. The method according to claim 1, wherein a preformed hollow profile for a hot water channel and a preformed hollow profile for a mixed water channel is provided.

5. The method according to claim 3, wherein an additional preformed hollow profile for a cold water channel is provided.

6. The method according to claim 3, wherein a molded piece is provided for receiving functional elements, a mixing cartridge, or a thermostatic element.

7. The method according to claim 1, wherein the hollow profile or the hollow profiles are produced by deep drawing, tubular molding, or heat forming.

8. The method according to claim 1, wherein the hollow profile or the hollow profiles, even before manufacturing of the housing, have connection geometries for water connections or water lines, especially threads.

9. The method according to claim 1, wherein the housing is made of metal, plastic or ceramic.

10. The method according to claim 1, wherein the hollow profile or the hollow profiles are made of metal, plastic or ceramic.

11. The method according to claim 1, wherein the coupling layer is made of metal, plastic or ceramic.

12. A housing for sanitary fixtures comprising:
a water channel provided in the housing, the water channel being made of preformed hollow profiles, the hollow profiles being connected in a form- and/or material-locking way with the housing.

13. The housing according to claim 12, wherein, in addition to the water channel, a molded piece is provided in the housing for receiving functional elements, a mixing cartridge, or thermostat cartridge.

14. The housing according to claim 12, wherein a molded piece for accommodating functional elements made of a preformed hollow profile is provided.

15. The housing according to claim 12, wherein the preformed hollow profiles are made of metal, plastic or ceramic.
